(19) United States
(12) Patent Application Publication
(10) Pub. No.: US 2011/0225363 A1
(43) Pub. Date: Sep. 15, 2011

(54) STORAGE PROCESSING DEVICE

(75) Inventors: Yukihito HARA, Nagoya-shi (JP); Jumpei Shimada, Nagoya-shi (JP); Satoru Goto, Nagoya-shi (JP)

(73) Assignee: Buffalo Inc., Nagoya-shi (JP)

(21) Appl. No.: 13/043,819

(22) Filed: Mar. 9, 2011

(30) Foreign Application Priority Data
Mar. 10, 2010 (JP) 2010-053304

(51) Int. Cl. G06F 12/00

(52) U.S. Cl. 711/114; 711/E12.001

(57) ABSTRACT

A storage processing device to which a plurality of removable hard disk drives and the like are connected and includes: a RAID controller for controlling RAID including the removable hard disk drives and the like, and an available storage capacity setting unit for setting an available storage capacity which is a storage capacity actually available for a predetermined storage unit that is one of the storage units connected to the storage processing in the disk array, on the basis of the real storage capacity of the predetermined storage unit, when the predetermined storage unit is connected to the storage processing device.

### CROSS REFERENCE TO RELATED APPLICATIONS

This application is based upon and claims the benefit of priority from prior Japanese Patent Application No. 2010-053304, filed on Mar. 10, 2010, the entire contents of which are incorporated herein by reference.

### BACKGROUND OF THE INVENTION

1. Field of the Invention

The present invention relates to a storage processing device to which plural storage units are connected.

2. Description of the Related Art

Digital data stored in storage processing devices such as a data server and a file server has been considered very important. Thus, systems based on the redundant arrays of inexpensive disks (RAID) technique multiplexing plural storage units and building a virtual storage unit by combining plural storage units have been widely used for preventing the loss of digital data caused by the failure of storage units, such as hard disk drives (HDDs), which are built in or externally attached to these servers or other similar devices.

However, in a RAID system, plural storage units are connected to, for example, a server under the requirement that a storage unit newly connected to the server in place of a failed storage unit should have a storage capacity not smaller than the storage capacity of each of the other storage units already connected to the server.

In view of the above, a mirroring (or duplication) technique has been proposed which enables a failed storage unit to be replaced with a new storage unit in the RAID system even when the failed storage unit and the new storage unit have different real storage capacities (see, for example, Japanese Patent Application Publication No. 2004-265312).

The technique is based on the storage capacity of the storage units such as HDDs, and a partition-related technique for dividing the storage units into plural areas and enabling the storage units to be used as if it were plural storage units.

To put it concretely, even in the case where an intact storage unit already connected to the server has a larger real storage capacity than a new storage unit which has replaced a failed storage unit, the contents stored in the partitions formed in the intact storage unit are duplicated in the new storage unit and thus a mirrored state is created if the total of storage capacities of the partitions formed in the intact storage unit is not larger than the real storage capacity of the new storage unit.

Since a user can select at will the storage capacities of the partitions formed in the storage unit, unavailable areas increase in the storage unit as the difference between the total of storage capacities of the partitions of the intact storage unit and the real storage capacity of the storage unit becomes larger.

### SUMMARY OF THE INVENTION

According to a first aspect of the present invention, there is provided a storage processing device to which a plurality of storage units are connected, the storage processing device comprising: a disk array controller for controlling a disk array including the plural storage units; and an available storage capacity setting unit for setting an available storage capacity which is a storage capacity actually available for a predetermined storage unit that is one of the storage units connected to the storage processing in the disk array, on the basis of the real storage capacity of the predetermined storage unit, when the predetermined storage unit is connected to the storage processing device.

In such a storage processing device, the available storage capacity is a value considered as the nominal storage capacity of the storage unit, and does not largely differ from the real storage capacity of the storage unit. Thus, the storage capacity of the storage unit can be effectively utilized.

Moreover, in such a storage processing device, the disk array can be built by use of the plural storage units whose nominal storage capacities are equal to each other, even when the real storage capacities of the plural storage units are different from each other.

According to a second aspect of the present invention, there is provided a storage processing device wherein the disk array controller makes the plural storage units redundant.

According to a third aspect of the present invention, there is provided a storage processing device wherein the disk array controller collectively controls the plural storage units as if they are a single virtual storage unit.

According to a fourth aspect of the present invention, there is provided a storage processing device wherein the available storage capacity setting unit selects as the available storage capacity a storage capacity that is created by equating a specified digit of the number denoting the real storage capacity in a certain unit and the digits lower than the specified digit, both to zero.

According to a fifth aspect of the present invention, there is provided a storage processing device wherein when the specified digit is 4 or less, the available storage capacity setting unit sets as the available storage capacity a real storage capacity created by equating the specified digit and the lower digit all to zero, and when the specified digit is 5 or more, the available storage capacity setting unit sets as the available storage capacity a real storage capacity created by equating the specific digit to 5 and the lower digits to zero.

According to a sixth aspect of the present invention, there is provided a storage processing device wherein the available storage capacity setting unit sets as the available storage capacity a value calculated from the real storage capacity by using a predetermined formula.

According to a seventh aspect of the present invention, there is provided a storage processing device wherein the available storage capacity setting unit writes the available storage capacity of the predetermined storage unit onto the predetermined storage unit.

### BRIEF DESCRIPTION OF THE DRAWINGS

FIG. 1 is an external view of a network attached storage (NAS) according to an embodiment of the present invention.

FIG. 2 diagrammatically shows the overall configuration of a communication system according to the embodiment of the present invention.

FIG. 3 schematically shows a configuration of the NAS according to the embodiment of the present invention.

FIG. 4 exemplifies an available storage capacity table according to the embodiment of the present invention.

FIG. 5 illustrates the locations of available storage capacities in the removable hard disk drives according to the embodiment of the present invention.

FIG. 6 is the flowchart of a first operation of the NAS according to the embodiment of the present invention.

FIG. 7 is the flowchart of a second operation of the NAS according to the embodiment of the present invention.

### DETAILED DESCRIPTION OF THE EMBODIMENTS

An embodiment of the invention will be described by referring to the attached drawings. Description will be given specifically to the following points: (1) an external structure of a network attached storage (NAS); (2) an overall configuration of a communication system; (3) a configuration of the NAS; (4) an operation of the NAS; (5) the advantageous effects; and (6) other embodiments.

Throughout the drawings of the embodiments described below, identical or similar constituents are denoted by the same or similar reference numerals. In a communication system of this embodiment, communication is performed in accordance with the DLNA guidelines.

### (1) External Configuration of NAS

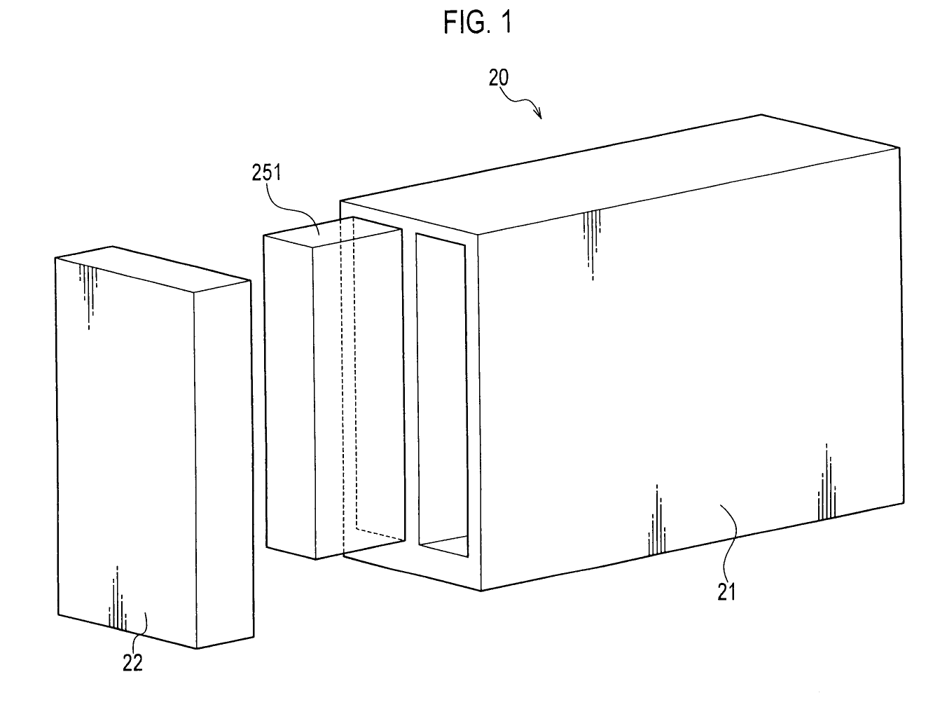

FIG. 1 shows an external structure of a NAS 20 according to an embodiment of the present invention.

As shown in FIG. 1, the NAS 20 includes a main body 21 and a lid section 22. Two removable hard disk drives (plural storage units) can be connected to the NAS 20. FIG. 1 shows a state where a removable hard disk drive 251 is connected to the NAS 20.

### (2) Overall Configuration of Communication System

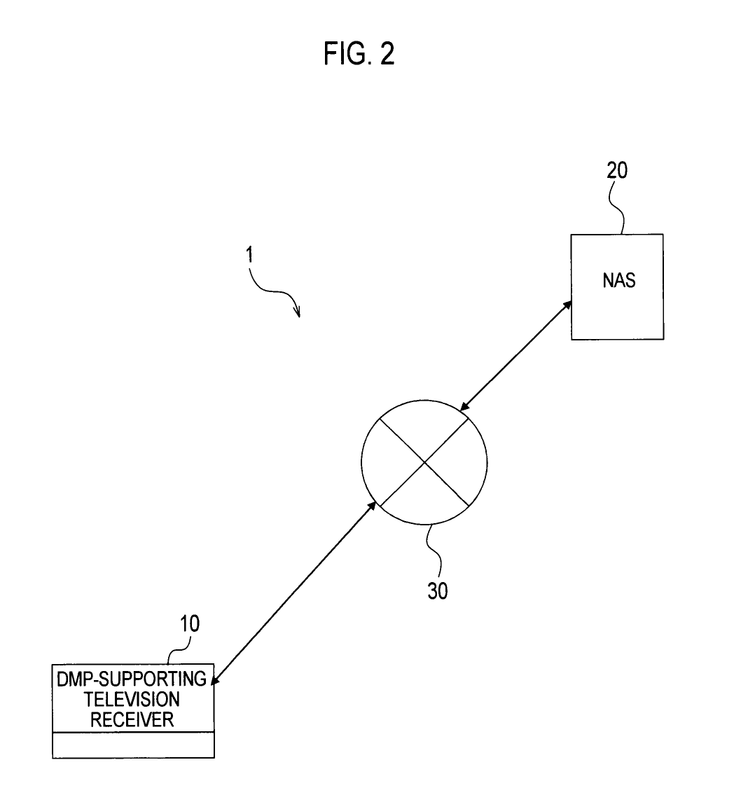

FIG. 2 diagrammatically shows the overall configuration of a communication system according to the embodiment of the present invention. As shown in FIG. 2, the communication system 1 includes a DMP (digital media player)-supporting television receiver 10, the NAS 20 and a network 30.

The DMP-supporting television receiver 10 requests a content, such as a video content or an audio content, accumulated in the NAS 20 through the network 30. The DMP-supporting television receiver 10 receives the content from the NAS 20, and displays the received content. The DMP-supporting television receiver 10 may be a personal computer.

The NAS 20 transmits the content requested by the DMP-supporting television receiver 10 to the DMP-supporting television receiver 10 through the network 30.

The network 30 is a local area network (LAN).

### (3) Configuration of NAS

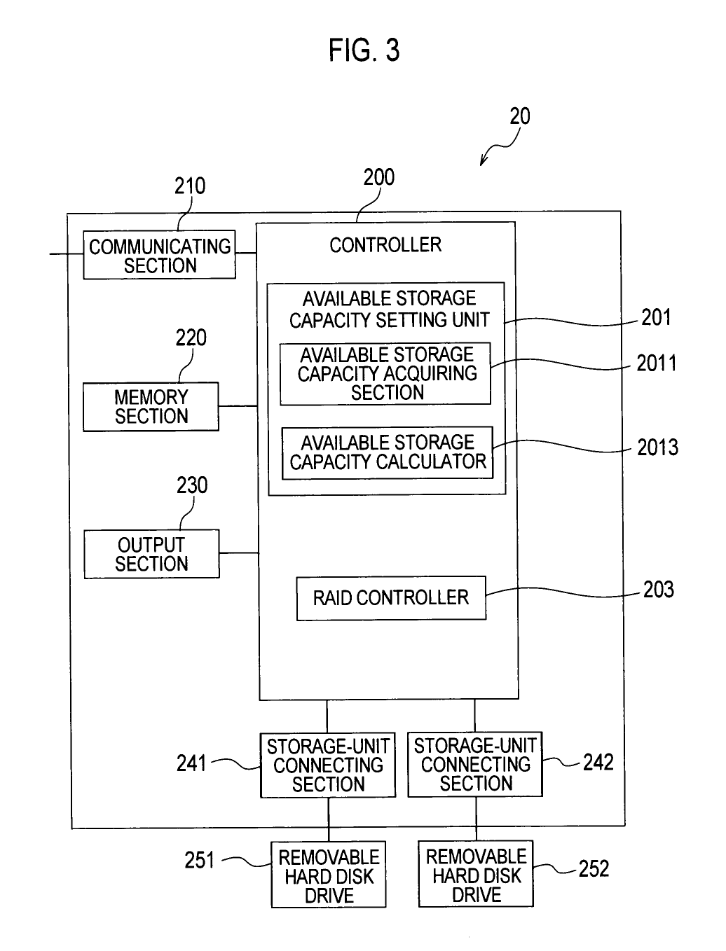

FIG. 3 schematically shows a configuration of the NAS 20 according to the embodiment of the present invention.

The NAS 20 provides the contents, such as video contents and audio contents, to the DMP-supporting television receiver 10 in the communication system 1. In addition, the NAS 20 performs mirroring between the removable hard disk drive 251 and a removable hard disk drive 252 by a RAID 1 system.

The NAS 20 includes a controller 200, a communicating section 210, a memory section 220, an output section 230, a storage-unit connecting section 241, a storage-unit connecting section 242, the removable hard disk drive 251, and the removable hard disk drive 252.

The controller 200 may be, for example, a central processing unit (CPU). The controller 200 controls the various functions of the NAS 20.

The communicating section 210 communicates with the DMP-supporting television receiver 10 via the network 30.

The memory section 220 may be, for example, a NAND flash memory. The memory section 220 stores various kinds of information to be used in the control performed by the NAS 20. To put it concretely, the memory section 220 stores an OS program, an available storage capacity table and an available storage capacity calculation formula that are described later, and the like.

The output section 230 may be a speaker or an LED, for example, and notifies the user of, for example, the state of executing exceptional processing.

The storage-unit connecting sections 241, 242 are used for respectively attaching the removable hard disk drives 251, 252 to the NAS 20. In the present embodiment, for the purpose of performing the mirroring by the RAID 1 system, the removable hard disk drive 251 is attached to the storage-unit attaching section 241, and the removable hard disk drive 252 is attached to the storage-unit attaching section 242.

Note that, in the present embodiment, the storage-unit connecting section 241 and the removable hard disk drive 251 are mainly used for the purpose of description. However, the storage-unit connecting section 242 and the removable hard disk drive 252 may be used instead of the storage-unit connecting section 241 and the removable hard disk drive 251.

The controller 200 includes an available storage capacity setting unit 201 and a RAID controller 203. The available storage capacity setting unit 201 includes an available storage capacity acquiring section 2011 and an available storage capacity calculator 2013.

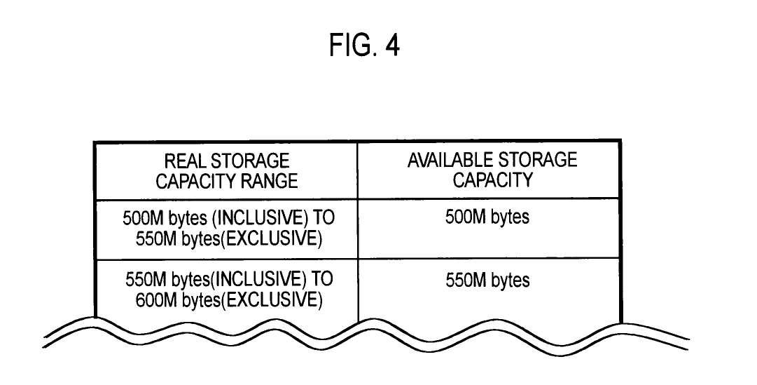

The available storage capacity setting unit 201 recognizes that the removable hard disk drive 251 is connected to the storage-unit connecting section 241. Then, the available storage capacity setting unit 201 acquires a real storage capacity of the removable hard disk drive 251. The real storage capacity is recorded in a predetermined sector in the removable hard disk drive 251. Then, the available storage capacity setting unit 201 acquires the available storage capacity table or the available storage capacity calculation formula from the memory section 220. The available storage capacity acquiring section (available storage capacity setting unit) 2011 acquires the available storage capacity of the removable hard disk drive 251 using the real storage capacity of the removable hard disk drive 251 and the available storage capacity table (see, for example, FIG. 4). The available storage capacity table includes the columns of real storage capacity range and available storage capacity. The available storage capacity is based on the value considered as the nominal storage capacity of the removable hard disk drive having a real storage capacity which is included in the real storage capacity range.

To put it concretely, in the available storage capacity table, when a real storage capacity represented in a specific unit is within a real storage capacity range of 500M bytes (inclusive) to 550 M bytes (exclusive), the real storage capacity rounded down to the hundreds digit is set as the available storage capacity of the real storage capacity. When a real storage capacity represented in the specific unit is within a real storage capacity range of 550 M bytes (inclusive) to 600 M bytes (exclusive), the real storage capacity rounded down to the tens digit by replacing the value of the tens digit with 5 is set as the storage capacity of the real storage capacity. For example, when the real storage capacity of the removable hard disk drive 251 is 512 M bytes, the available storage capacity acquiring section 2011 acquires 500 M bytes as the available storage capacity of the removable hard disk drive 251 using the available storage capacity table. In addition, when the real storage capacity of the removable hard disk drive 251 is 562 M bytes, the available storage capacity acquiring section 2011 acquires 550 M bytes as the available storage capacity of the removable hard disk drive 251 using the available storage capacity table.

Note that the available storage capacity table of FIG. 4 is an example and that the real storage capacity range and the available storage capacity may include values different from those in FIG. 4. The available storage capacity table may include figures different from those listed in the columns of the real storage capacity range and the available storage capacity.

The available storage capacity calculator 2013 (available storage capacity setting unit) calculates the available storage capacity of the removable hard disk drive 251 using the real storage capacity of the removable hard disk drive 251 and the available storage capacity calculation formula. The available storage capacity calculation formula calculates a value, which is considered as the nominal storage capacity of the removable hard disk drive, as the available storage capacity.

To put it concretely, the available storage capacity calculation formula is a formula for acquiring a value, which is obtained by dividing the real storage capacity by a predetermined value and subtracting the remainder from the real storage capacity, as the available storage capacity. For example, when the real storage capacity of the removable hard disk drive 251 is 512 M bytes, the available storage capacity calculator 2013 calculates 500 M bytes, which is obtained by dividing 512 M bytes by 100 M bytes and subtracting 12 M bytes as the remainder from 512 M bytes by use of the available storage capacity calculation formula, as the available storage capacity of the removable hard disk drive 251. The available storage capacity calculation formula may be a formula for calculating the available storage capacity by using logic different from that described above.

The available storage capacity setting unit 201 writes the available storage capacity of the removable hard disk drive 251, which is acquired by the available storage capacity acquiring section 2011 or calculated by the available storage capacity calculator 2013, onto a predetermined sector of the removable hard disk drive 251.

The RAID controller (disk array controller) 203 controls the removable hard disk drives 251, 252 connected to the NAS 20 using the mirroring of the RAID 1 system. The area corresponding to the available storage capacity of the removable hard disk drive 251 is treated as the target of the mirroring by the RAID controller 203. The available storage capacity of the removable hard disk drive 251 is written onto the predetermined sector of the removable hard disk drive 251 by the available storage capacity setting unit 201. Similarly, the area corresponding to the available storage capacity of the removable hard disk drive 252 is treated as the target of the mirroring by the RAID controller 203. The available storage capacity of the removable hard disk drive 252 is written onto a predetermined sector of the removable hard disk drive 252 by the available storage capacity setting unit 201.

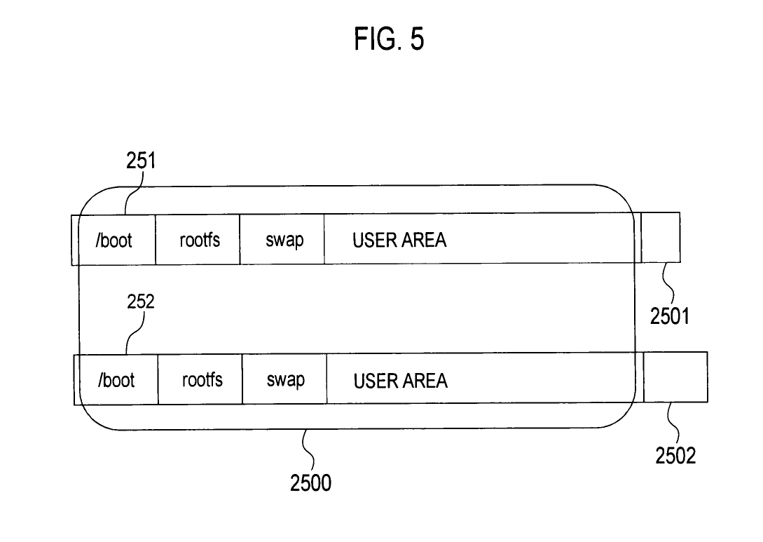

As shown as an example in FIG. 5, the area 2500 corresponding to the available storage capacities of the removable hard disk drives 251, 252 is the target of the mirroring. On the other hand, the area 2501 of the removable hard disk drive 251 and the area 2502 of the removable hard disk drive 252 are those areas which the RAID controller 203 does not treat as the target of the mirroring. For example, in the case where the available storage capacity of a new removable hard disk drive that replaces the removable hard disk drive 251 because of the failure is different from the available storage capacity of the removable hard disk drive 252 that has been connected to the NAS 20, the RAID controller 203 may notify the user of the state of executing exceptional processes.

### (4) Operations of NAS

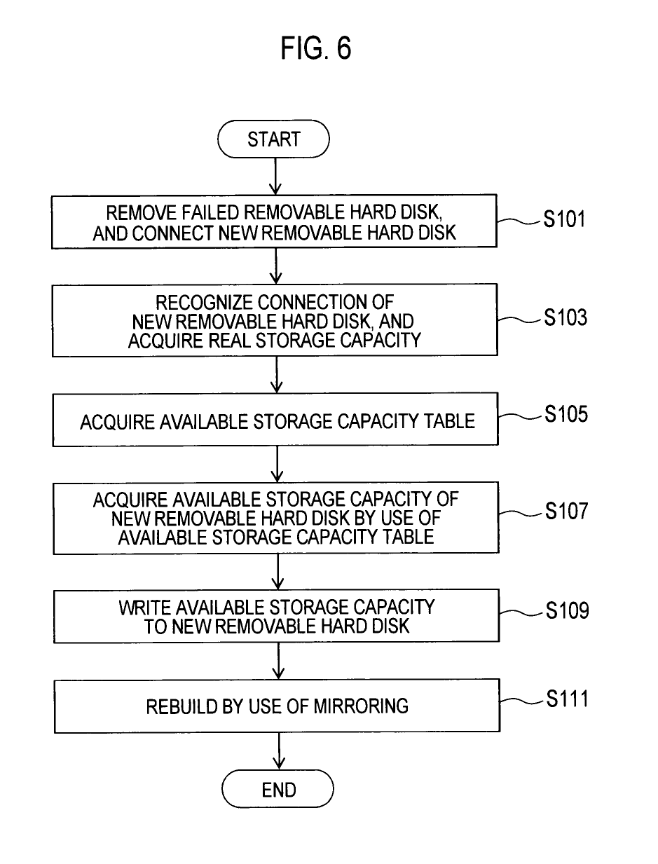

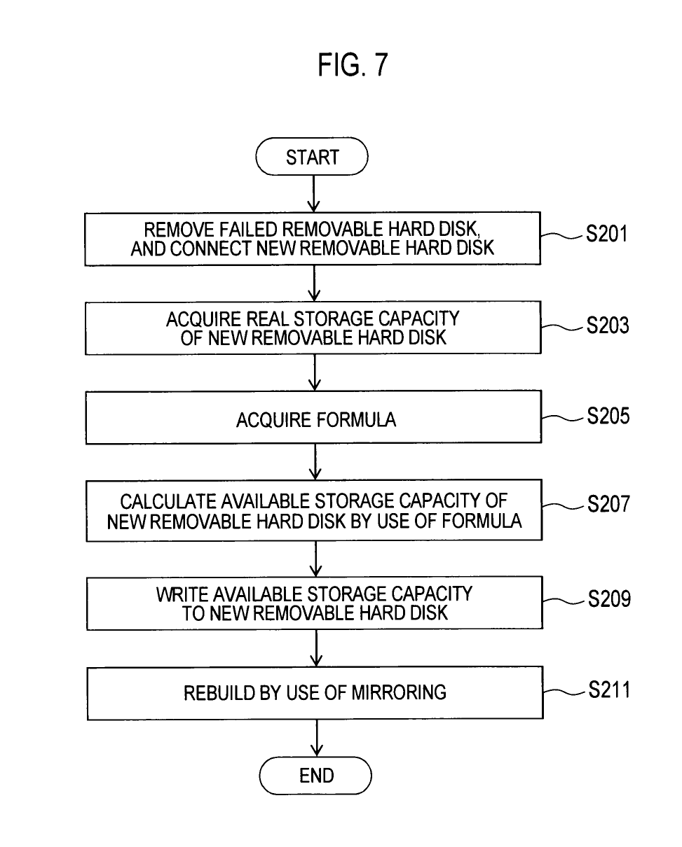

Descriptions will be provided for operations of the NAS 20. FIGS. 6 and 7 are flowcharts showing the operations of the NAS 20.

To begin with, a first operation is described below by use of FIG. 6. In the first operation, the NAS 20 rebuilds a removable hard disk drive X newly connected to the NAS 20 by use of the removable hard disk drive 252 that has been connected to the NAS 20, when the removable hard disk drive 251 connected to the NAS 20 executing the mirroring by RAID 1 system fails.

In step S101, the user removes the failed removable hard disk drive 251 from the storage-unit connecting section 241, and connects the new removable hard disk drive X to the storage-unit connecting section 241. The removable hard disk drive X is already formatted.

In step S103, the available storage capacity setting unit 201 recognizes that the removable hard disk drive X is connected to the storage-unit connecting section 241. Then, the available storage capacity setting unit 201 acquires the real storage capacity of the removable hard disk drive X, the real storage capacity being stored in a predetermined sector of the removable hard disk drive X.

In step S105, the available storage capacity setting unit 201 acquires the available storage capacity table from the memory section 220.

In step S107, the available storage capacity acquiring section 2011 acquires the available storage capacity of the removable hard disk drive X by use of the real storage capacity of the removable hard disk drive X and the available storage capacity table.

In step S109, the available storage capacity setting unit 201 writes the available storage capacity of the removable hard disk drive X acquired by the available storage capacity acquiring section 2011 onto the predetermined sector of the removable hard disk drive X.

In step S111, the RAID controller 203 rebuilds the removable hard disk drive X by use of the removable hard disk drive 252 using the mirroring of the RAID 1 system.

Next, a second operation, which is different from the first operation, is described below by use of FIG. 7. In the second operation, the NAS 20 rebuilds the removable hard disk drive X newly connected to the NAS 20 by use of the removable hard disk drive 252 that has been connected to the NAS 20, when the removable hard disk drive 251 connected to the NAS 20 executing the mirroring by the RAID 1 system fails.

In step S201, the user removes the failed removable hard disk drive 251 from the storage-unit connecting section 241, and connects the new removable hard disk drive X to the storage-unit connecting section 241. The removable hard disk drive X is already formatted.

In step S203, the available storage capacity setting unit 201 recognized that the removable hard disk drive X is connected to the storage-unit connecting section 241. Then, the available storage capacity setting unit 201 acquires the real storage capacity of the removable hard disk drive X, the real storage capacity being stored in a predetermined sector of the removable hard disk drive X.

In step S205, the available storage capacity setting unit 201 acquires the available storage capacity calculation formula from the memory section 220.

In step S207, the available storage capacity calculator 2013 calculates the available storage capacity of the removable hard disk drive X by use of the real storage capacity of the removable hard disk drive X and the available storage capacity calculation formula.

In step S209, the available storage capacity setting unit 201 writes the available storage capacity of the removable hard disk drive X, which is calculated by the available storage capacity calculator 2013, onto a predetermined sector of the removable hard disk drive X.

In step S211, the RAID controller 203 rebuilds the removable hard disk drive X by use of the removable hard disk drive 252 using the mirroring by the RAID 1 system.

### (5) The Advantageous Effects

In the embodiment of the present invention, the available storage capacity acquiring section 2011 of the NAS 20 acquires the value, which is considered as the nominal storage capacity of the removable hard disk drive 251, as the available storage capacity. The available storage capacity calculator 2013 of the NAS 20 calculates the value, which is considered as the nominal storage capacity of the removable hard disk drive 251, as the available storage capacity.

In the NAS 20 described above, the available storage capacity is the value considered as the nominal storage capacity of the removable hard disk drive 251, and accordingly does not largely differ from the real storage capacity of the removable hard disk drive 251. Thus, the storage capacity of the removable hard disk drive 251 can be effectively utilized.

In addition, in the NAS 20 described above, the mirroring of the RAID 1 system can be rebuilt by using the plural removable hard disks whose nominal storage capacities are equal to each other, even when the real storage capacities of the plural removable hard disks are different from each other.

### (6) Other Embodiments

As described above, the present invention has been described by way of embodiment. However, it should not be understood that the description and the drawings attached thereto limit the present invention. Various alternative embodiments, examples, and operation techniques will be easily found by those skilled in the art.

The processing in the storage processing device of the present invention is not limited to that for connecting a new storage unit to the storage processing device in place of a failed storage unit. For example, the storage processing device may be configured to acquire or calculate an available storage capacity and to write the available storage capacity onto a predetermined sector in the storage processing device in the case where a new storage unit is connected to the storage processing device, instead of the case where the new storage unit replaces the failed storage unit. In addition, the available storage capacity may be written onto a table in the predetermined sector of the storage processing device.

The storage processing device of the present invention is not necessarily limited to the NAS. Examples of the storage processing unit include a data server and a file server.

The available storage capacity of the storage unit according to the present invention may be a value other than the value considered as the nominal storage capacity of the storage unit.

The storage unit according to the present invention is not limited to the removable hard disk. Examples of the storage unit include storage units such as a HDD and a solid state drive (SSD).

The number of storage units to be connected is not necessarily two. Three or more storage units may be connected.

The storage unit according to the present invention may be built in the NAS, or externally attached to the NAS.

The storage processing device according to the present invention may form a RAID system other than the mirroring of RAID 1. For example, the storage processing device according to the present invention may form RAID 5 in which plural storage units are combined to form a virtual storage unit.

The above-described embodiment has been described on the assumption that the network 30 is a LAN. However, examples of the network 30 include a network connectable via a Wide Area Network (WAN).

As described above, the present invention naturally includes various embodiments which are not described herein. Accordingly, the present invention should be limited only by the matters to define the invention in the scope of claims regarded as appropriate based on the description.

### INDUSTRIAL APPLICABILITY

The storage processing device according to the present invention makes it possible to effectively use the storage capacity of any one of the storage units in the RAID system, and the present invention is useful for application to storage processing devices.

What is claimed is:

1. A storage processing device to which a plurality of storage units are connected, the storage processing device comprising:
a disk array controller for controlling a disk array including the plural storage units; and
an available storage capacity setting unit for setting an available storage capacity which is a storage capacity actually available for a predetermined storage unit that is one of the storage units connected to the storage processing in the disk array, on the basis of the real storage capacity of the predetermined storage unit, when the predetermined storage unit is connected to the storage processing device.

2. The storage processing device according to claim 1, wherein the disk array controller makes the plural storage units redundant.

3. The storage processing device according to claim 1, wherein the disk array controller collectively controls the plural storage units as if they are a single virtual storage unit.

4. The storage processing device according to claim 1, wherein the available storage capacity setting unit selects as the available storage capacity a storage capacity that is created by equating a specified digit of the number denoting the real storage capacity in a certain unit and the digits lower than the specified digit, both to zero.

5. The storage processing device according to claim 4, wherein
when the specified digit is 4 or less, the available storage capacity setting unit sets as the available storage capacity a real storage capacity created by equating the specified digit and the lower digit all to zero, and
when the specified digit is 5 or more, the available storage capacity setting unit sets as the available storage capacity a real storage capacity created by equating the specific digit to 5 and the lower digits to zero.

6. The storage processing device according to claim 1, wherein the available storage capacity setting unit sets as the available storage capacity a value calculated from the real storage capacity by using a predetermined formula.

7. The storage processing device according to claim 1, wherein the available storage capacity setting unit writes the available storage capacity of the predetermined storage unit onto the predetermined storage unit.
